(19) United States
(12) Patent Application Publication
(10) Pub. No.: US 2016/0192283 A1
(43) Pub. Date: Jun. 30, 2016

(54) METHOD FOR SEARCHING WIRELESS LAN AND METHOD FOR TRANSFERRING WIRELESS LAN SEARCH INFORMATION

(71) Applicant: INTELLECTUAL DISCOVERY CO., LTD., Seoul (KR)

(72) Inventors: Jin Sam KWAK, Uiwang-si (KR); Ju Hyung SON, Uiwang-si (KR); Hyun Oh OH, Gwacheon-si (KR); Yong Ho KIM, Uiwang-si (KR)

(73) Assignee: INTELLECTUAL DISCOVERY CO., LTD., Seoul (KR)

(21) Appl. No.: 15/064,638

(22) Filed: Mar. 9, 2016

Related U.S. Application Data
(63) Continuation of application No. PCT/KR2014/008524, filed on Sep. 12, 2014.

(30) Foreign Application Priority Data
Sep. 12, 2013 (KR) 10-2013-0109687
Sep. 12, 2013 (KR) 10-2013-0109688
Mar. 31, 2014 (KR) 10-2014-0038293
Mar. 31, 2014 (KR) 10-2014-0038294
Mar. 31, 2014 (KR) 10-2014-0038295

(51) Int. Cl. H04W 48/16

(52) U.S. Cl. CPC H04W 48/16; H04W 84/12

(57) ABSTRACT

A method for searching a wireless LAN by a mobile device is provided. The method may include: searching a small cell base station; transferring information about the searched small cell base station to a macro base station; receiving search information of wireless LAN access points in a local area of the mobile device from the macro base station; and performing a search for a wireless LAN access point on the basis of the received search information of the wireless LAN access points.

### CROSS-REFERENCE TO RELATED APPLICATION

This application is a continuation application of PCT Application No. PCT/KR2014/008524 filed on Sep. 12, 2014, which claims the benefit of Korean Patent Application No. 10-2014-0038293 filed on Mar. 31, 2014, Korean Patent Application No. 10-2014-0038294 filed on Mar. 31, 2014, Korean Patent Application No. 10-2014-0038295 filed on Mar. 31, 2014, Korean Patent Application No. 10-2013-0109687 filed on Sep. 12, 2013 and Korean Patent Application No. 10-2013-0109688 filed on Sep. 12, 2013, the entire disclosures of which are incorporated herein by reference.

### TECHNICAL FIELD

The present disclosure relates to a method for searching a wireless LAN and a method for transferring wireless LAN search information.

### BACKGROUND

A base station in a cellular network transmits/receives data to/from devices included in a wide service area, i.e., coverage. However, the cellular network base station has a wide coverage range, but has a lower data transmission speed than a wireless LAN, and charges a data communication fee for data transmission to a user on a per-packet basis.

On the other hand, the wireless LAN does not charge a data communication fee for data transmission to a user on a per-packet basis, and has a high data transmission speed. However, an access point of the wireless LAN has a narrow coverage range, and, thus, a mobile device cannot freely transmit/receive data.

Due to these characteristics of the cellular network and the wireless LAN, a mobile device capable of accessing both of the cellular network and the wireless LAN searches an accessible wireless LAN access point before starting data communication, and if there is no accessible wireless LAN access point, the mobile device performs data communication through the cellular network.

However, in order to search a wireless LAN access point, the mobile device needs to continuously apply power to a wireless LAN interface and regularly checks whether a wireless LAN signal is received from a wireless LAN access. Therefore, there is an increase in a load required for searching and accessing a wireless LAN access point.

Recently, in order to solve sharply increased data problems in a mobile communication network, there has been actively studied data offloading which is performed using an unlicensed band by interworking with a wireless LAN which can be freely used without permission. Further, the 3rd Generation Partnership Project (3GPP) established the cellular-wireless LAN interworking standards. Accordingly, there has been an attempt to solve traffic congestion problems in a cellular network by performing subscriber authentication to get access to a 3GPP network even if access is made through a wireless LAN.

Further, in order to solve sharply increased data traffic problems in a cellular system, the 3GPP LTE-A Release 12 has standardized cellular-wireless LAN interworking or small cell access. The most important problem to be solved for the cellular-wireless LAN interworking or small cell access is to detect a wireless LAN or a small cell as an access target and rapidly make a connection. Accordingly, in the Institute of Electrical and Electronics Engineers (IEEE) 802.11, the standards for more rapid access to a wireless LAN are defined.

The Quality of Service (QoS) structure for wireless LAN interworking as defined in the 3GPP standards provides Wireless Local Area Network (WLAN) 3GPP IP access in a 3GPP network using a wireless LAN. That is, traffic in a 3GPP network can be distributed through a wireless LAN by wireless LAN interworking.

However, in order to access the wireless LAN, a detection process for obtaining information required for access needs to be performed, and, thus, an access delay occurs. Further, a wireless packet (control frame) needs to be transmitted/received, and, thus, power consumption occurs.

Meanwhile, Korean Patent Laid-open Publication No. 10-2011-0139960 (entitled “Method and apparatus of convergence terminal for discovering WLAN access point”) describes a method and apparatus for discovering a WLAN access point, including: receiving information about WLAN access point distribution in a base station coverage from a base station of a cellular network by a device which can access the cellular network and a WLAN; determining presence or absence of a search for a WLAN access point in the base coverage and a search cycle on the basis of the received information; and performing a WLAN search.

### DISCLOSURE OF THE INVENTION

### Problems to be Solved by the Invention

In view of the foregoing, the present disclosure provides a method of configuring a cellular cell to be divided into one or more sectors and thus enabling a mobile device to effectively search a wireless LAN with the help of a base station.

Further, the present disclosure provides a method of configuring a baseband unit to include multiple radio head cells connected to the baseband unit and thus effectively transferring wireless LAN access point search information to a mobile device.

Furthermore, the present disclosure provides a method for transferring wireless LAN search information that enables a mobile device to effectively search a wireless LAN access point in a local area by transferring information required to search the wireless LAN access point to the mobile device by a macro base station.

However, problems to be solved by the present disclosure are not limited to the above-described problems. There may be other problems to be solved by the present disclosure.

### Means for Solving the Problems

In accordance with an aspect of the present disclosure, a method for transmitting information about a wireless LAN may include: transmitting information about a wireless LAN access point located in each of multiple areas included in a base station to a mobile device located in each area by the base station.

Further, in accordance with another aspect of the present disclosure, a method for searching a wireless LAN may include: receiving information about a wireless LAN access point by a mobile device from a base station; and performing a wireless LAN search on the basis of the received information about the wireless LAN access point. Herein, the information about the wireless LAN access point relates to a wireless LAN access point located in each of multiple areas included in the base station and also relates to a wireless LAN access point included in an area where the mobile device is located.

Furthermore, in accordance with yet another aspect of the present disclosure, a method for transmitting information about a wireless LAN may include: configuring, by a baseband unit, multiple remote radio head cells with multiple remote radio heads connected to the baseband unit; and transmitting information about a wireless LAN access point present within a range of the baseband unit or information about a wireless LAN access point present within a range of a cell which at least one remote radio head is in charge of to one or more mobile devices located in a range of a network system including the baseband unit and the remote radio head cells.

Moreover, in accordance with still another aspect of the present disclosure, a network system may include: a baseband unit; and multiple remote radio heads connected to the baseband unit, and the baseband unit transmits information about a wireless LAN access point present within a range of a cell which the remote radio heads are in charge of to one or more mobile devices located in a range of a network system.

Further, in accordance with still another aspect of the present disclosure, a method for access to a wireless LAN may include: receiving information about a wireless LAN access point by a mobile device from a remote radio head; and performing access to the wireless LAN access point on the basis of the received information about the wireless LAN access point. Herein, the remote radio head accesses a baseband unit, and each remote radio head transmits information about a wireless LAN access point present within a range of a cell which the remote radio head is in charge of or information about a wireless LAN access point present within a range of the baseband unit.

Further, in accordance with still another aspect of the present disclosure, a method for searching a wireless LAN by a mobile device may include: searching a small cell base station; transferring information about the searched small cell base station to a macro base station; receiving search information of wireless LAN access points in a local area of the mobile device from the macro base station; and performing a search for a wireless LAN access point on the basis of the received search information of the wireless LAN access points.

Further, in accordance with still another aspect of the present disclosure, a method for searching a wireless LAN by a mobile device may include receiving, from the macro base station, information about a small cell base station located around a wireless LAN adjacent to the mobile device among small cell base stations included in a management range of a macro base station; searching the small cell base station; and searching wireless LAN access points around the small cell base station.

Further, in accordance with still another aspect of the present disclosure, a method for searching a wireless LAN by a mobile device may include receiving, from the macro base station, information about a small cell base station located around a wireless LAN adjacent to the mobile device among small cell base stations included in a management range of a macro base station; searching the small cell base station; receiving search information of wireless LAN access points around the small cell base station; and performing a search for a wireless LAN access point by the mobile device on the basis of the received search information of the wireless LAN access points.

Further, in accordance with still another aspect of the present disclosure, a method for searching a wireless LAN by a mobile device may include searching a small base station located around the mobile device; transferring information about the small cell base station to a macro base station; receiving, from the macro base station, an instruction to search a wireless LAN access point around the small cell base station; receiving search information of the wireless LAN access point around the small cell base station; searching the wireless LAN access point; transferring a search result of the wireless LAN access point to the macro base station; and receiving an instruction to move to the wireless LAN access point from the macro base station.

Further, in accordance with still another aspect of the present disclosure, a method for transferring wireless LAN search information by a macro base station may include transferring information about a small cell base station included in a management range of a macro base station to a mobile device; receiving information of a small cell base station searched by the mobile device; and transferring search information of a wireless LAN access point in a local area of the mobile device to the mobile device.

Further, in accordance with still another aspect of the present disclosure, a method for transferring wireless LAN search information by a macro base station may include transferring, to the mobile device, information about a small cell base station located around a wireless LAN adjacent to a mobile device among small cell base stations included in a management range of the macro base station.

Further, in accordance with still another aspect of the present disclosure, a method for transferring wireless LAN search information by a macro base station may include receiving information about a small cell base station around a mobile device searched by a mobile device; transferring an instruction to the mobile device to search a wireless LAN access point around the small cell base station; receiving a search result of the wireless LAN access point searched by the mobile device; and transferring an instruction to the mobile device to move to the wireless LAN access point.

### Effects of the Invention

According to any one of the above-described aspects of the present disclosure, a base station locally divides an area and transmits wireless LAN search information. Therefore, it is possible to transfer search information only of a few wireless LANs included in the corresponding area and thus possible to improve a radio resource utility rate.

Further, according to any one of the above-described aspects of the present disclosure, information and the number of wireless LANs to be searched by a mobile device are limited. Therefore, the amount of information used for a search is reduced. Thus, it becomes simple for the mobile device to perform a wireless LAN search, and it is possible to efficiently use power of the mobile device.

Furthermore, according to any one of the above-described aspects of the present disclosure, a mobile device receives search information of a wireless LAN access point close to a location of the mobile device from a base station. Thus, it is possible to improve wireless LAN search efficiency of the mobile device.

Moreover, according to any one of the above-described aspects of the present disclosure, a mobile device receives search information of a wireless LAN access point close to a location of the mobile device from a base station. Thus, information and the number of wireless LANs to be searched by the mobile device are limited. Therefore, the amount of information used for a search is reduced. Thus, it becomes simple for the mobile device to perform a wireless LAN search, and it is possible to efficiently use power of the mobile device.

### BRIEF DESCRIPTION OF THE DRAWINGS

FIG. 1 illustrates a network system to which an exemplary embodiment of the present disclosure is applied;

FIG. 2 is a diagram illustrating a dynamic information transfer method to which an exemplary embodiment of the present disclosure is applied;

FIG. 3 is a diagram illustrating a dynamic management process of WLAN access information broadcasting through a handover to which an exemplary embodiment of the present disclosure is applied;

FIG. 4 is a diagram illustrating a method for transferring WLAN information through beamforming to which an exemplary embodiment of the present disclosure is applied;

FIG. 5 illustrates a network system to which another exemplary embodiment of the present disclosure is applied;

FIG. 6 is a diagram illustrating a method for transmitting WLAN search information in an environment including multiple remote radio head cells to which another exemplary embodiment of the present disclosure is applied;

FIG. 7 is a diagram illustrating a method for transmitting WLAN search information to which another exemplary embodiment of the present disclosure is applied in a case where a cell ID which multiple remote radio heads are in charge of is the same as a cell ID used by a baseband unit;

FIG. 8 is a diagram illustrating a dynamic information transfer method of system information in a case where a cell ID which multiple remote radio heads are in charge of is the same as a cell ID used by a baseband unit to which another exemplary embodiment of the present disclosure is applied;

FIG. 9 illustrates an example of cooperative communication among multiple base stations or multiple wireless radio heads in a network system applicable to a method for transmitting WLAN search information to which another exemplary embodiment of the present disclosure is applied;

FIG. 10 illustrates a system supporting a WLAN search and a transfer of WLAN search information by a mobile device to which yet another exemplary embodiment of the present disclosure is applied;

FIG. 11 is a detailed flowchart showing a method of a WLAN search and a transfer of WLAN search information by a mobile device to which yet another exemplary embodiment of the present disclosure is applied;

FIG. 12 is a detailed flowchart showing a method of a WLAN search and a transfer of WLAN search information by a mobile device to which still another exemplary embodiment of the present disclosure is applied; and

FIG. 13 is a detailed flowchart showing a method of a WLAN search and a transfer of WLAN search information by a mobile device to which still another exemplary embodiment of the present disclosure is applied.

### MODE FOR CARRYING OUT THE INVENTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements unless context dictates otherwise.

Hereinafter, a method for searching a WLAN and a method for transferring WLAN search information in accordance with an exemplary embodiment of the present disclosure will be described in detail with reference to the accompanying drawings.

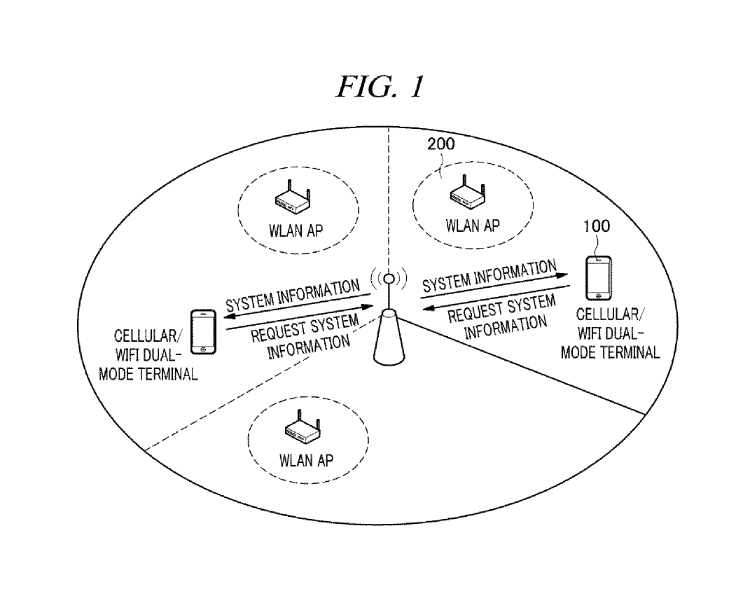

FIG. 1 illustrates a network system to which an exemplary embodiment of the present disclosure is applied.

Referring to FIG. 1, a system supporting a WLAN search and a transfer of WLAN search information by a mobile device may include a mobile device (User Equipment (UE)) 100, a WLAN access point (WLAN AP) 200, and a base station (Enhanced NodeB (eNB) or Radio Network Controller (RNC)) 300.

The UE 100 includes two kinds of wireless modules including a WLAN module and a cellular module. The UE 100 performs communication as being connected to a cellular system, searches the WLAN AP 200, accesses a WLAN by a link process, and then transmits data through the WLAN. Herein, the communication with the WLAN uses a different radio frequency from the cellular system connected to the UE 100, and in order to perform a WLAN search for discovering the WLAN AP 200, a WLAN scanning process for searching another frequency band is performed.

The UE 100 located within one of multiple areas divided from a cell of the base station 300 may request WLAN search information from the base station 300. Then, the UE 100 may receive search information of the WLAN AP 200 present within the corresponding area where the UE is located. Herein, the search information of the WLAN AP 200 may include a wireless network service set identification (SSID), a WLAN protocol version, information about a channel used, and the like. Further, the base station may be divided into cell units or sector units further divided from cells, and such cells or sectors may refer to the multiple areas. Otherwise, areas formed by beamforming may also refer to the multiple areas.

Meanwhile, the UE performs a search for the WLAN AP 200 on the basis of the search information of the WLAN AP 200 transferred from the base station 300. Herein, the WLAN AP 200 typically uses a radio resource in an unlicensed band, and, thus, the cost for data communication is lower than the cost for cellular communication. On the other hand, the cellular system has a large amount of data to be transmitted/received to/from the UE 100. Therefore, it is possible to use a method for transmitting/receiving data using a WLAN in order to reduce a load of the cellular system and process transmitted/received data of the mobile device at low cost.

Further, the base station 300 may transmit information about the WLAN AP 200 located in each of multiple areas included in the base station 300 to the UE 100 located in each area. Herein, the base station may unicast or multicast information about the accessible WLAN APs 200 present in the corresponding area where the UE 100 is located to the UE 100, or may broadcast the information for all of the UEs 100 within the area to hear. Referring to the information about the UE 100 accessible to the WLAN, the base station 300 may transfer the search information of the WLAN AP 200 using a communication protocol used by the UE 100 for mutual communication, i.e., a communication protocol through a control plane.

Further, in order to transfer the WLAN search information, the base station 300 may use a dynamic information transfer method of transferring the search information of the WLAN AP 200 only to the UE 100 in need of the search information of the WLAN AP 200. Therefore, it is possible to suppress waste of radio resources.

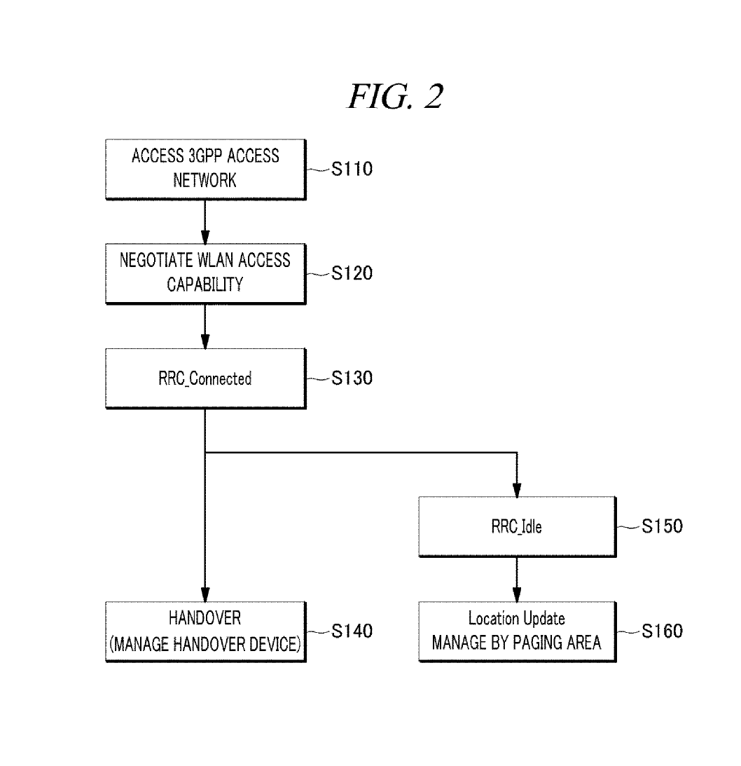

FIG. 2 is a diagram illustrating a dynamic information transfer method to which an exemplary embodiment of the present disclosure is applied.

Referring to FIG. 2, a dynamic information transfer method in accordance with an exemplary embodiment of the present disclosure may include: accessing a 3GPP access network of the base station 300 by the UE 100 (s110); receiving WLAN access capability information from the UE 100 and conducting negotiation by the base station 300 (s120); transitioning the UE 100 to a RRC_Connected or RRC_Idle state (s130, s140); and managing information about the UE 100 accessible to the WLAN by the base station 300 (s150, s160).

Firstly, the UE 100 may access the base station for communication (s110).

Then, in the receiving WLAN access capability information from the UE 100 and conducting negotiation by the base station 300 (s120), the base station 300 may negotiate capabilities supported by the UE 100 including the WLAN access capability from the UE 100 with capabilities supported by the base station 300. Further, in the receiving WLAN access capability information from the UE 100 and conducting negotiation by the base station 300 (s120), the WLAN access capability of the UE 100 may be transmitted to the base station in the form of a UE radio capability or a UE network capability. Then, the base station may transfer the received WLAN access capability to an entity such as a mobile management entity (MME). Therefore, the WLAN access capability includes whether or not it is possible to support a WLAN, a supportable wireless network service set identification (SSID), and whether or not it is possible to perform data redirection or data forwarding.

Then, after the access of the UE 100 to the base station 300 for communication is completed, the UE 100 transitions to a RRC_Connected state (s130). Herein, the RRC_Connected state may refer to a state where the base station 300 can manage a status of the UE 100 and transmit/receive data at any time.

Then, if there is no data transmitted/received between the UE 100 in the RRC_Connected state and the base station 300 for a certain period of time, the UE 100 may transit to a RRC_Idle state. Further, the UE 100 may be disconnected from the base station 300 in the RRC_Idle state (s150).

Then, in the managing information about the UE 100 accessible to the WLAN by the base station 300 (s150, s160), the base station 300 may classify and manage the UE 100 in the RRC_Connected state and the UE 100 in the RRC_Idle state. Further, if all of the base station 300 and the UE 100 support a WLAN interworking function, the base station 300 may classify and manage the UEs 100 as a separate management list.

In the RRC_Connected state, the UE 100 may perform a handover in order to change a cell. Therefore, the base station 300 may mange the UE 100 through the handover of the UE 100 and may detect a movement of the UE 100 in real time. Meanwhile, if the MME is not changed during the handover, the base station 300 can find out and manage a WLAN support capability of the UE 100 on the basis of the WLAN access capability information negotiated before transition to an initial RRC_Connected state stored in the MME. Otherwise, if the MME is changed during the handover, a new MME acquires the WLAN access capability information negotiated by the UE 100 before transition to an initial RRC_Connected state from the previous MME and thus can find out and manage a WLAN support capability of the UE 100. Therefore, after the handover, the base station 300 can find out whether or not the UE 100 having the WLAN access capability is present in a specific cell and thus dynamically find out whether or not WLAN information is transmitted on the basis of such information (s140).

In the RRC_Idle state, the UE 100 is disconnected from the base station 300. Herein, the base station 300 releases dynamic data relevant to the UE 100. Therefore, the base station 300 may manage the UE 100 through a so-called paging process of the UE 100, and may manage the UE 100 on the basis of location information transmitted by the UE 100 (s160).

To be specific, if the base station 300 has downlink data toward the UE 100, the base station 300 pages the UE 100 through the paging process and transmits the downlink data. Further, if the UE 100 has uplink data toward the base station 300, the UE 100 resets a connection to the base station 300 and transmits the uplink data. Herein, the UE 100 can regularly update its location. Therefore, the UE 100 can inform the base station 300 of its presence, and the base station 300 can acquire a new location of the UE 100. When the UE 100 regularly updates its location, the UE 100 transmits data including the WLAN access capability information to be managed by the MME. Then, the base station 300 may dynamically find out whether or not WLAN access information is transmitted on the basis of data about the location of the UE 100 supporting the WLAN.

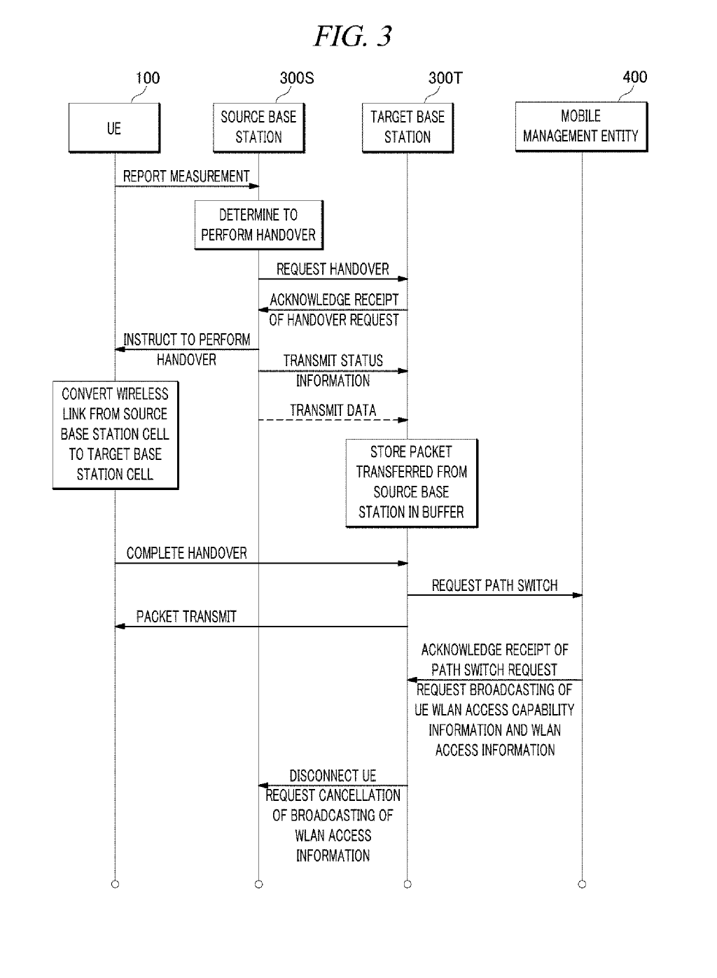

FIG. 3 is a diagram illustrating a dynamic management process of WLAN access information broadcasting through a handover to which an exemplary embodiment of the present disclosure is applied.

Referring to FIG. 3, the UE 100 may report a quality of a wireless channel of the base station 300 being accessed by the UE 100 to a source base station 300S. Then, if the reported quality of the wireless channel of the base station 300 satisfies a condition for performing a handover, a handover may be determined by a network. Then, a target base station 300T is selected on the basis of the reported quality of the wireless channel, and processes for the handover may be performed. If the source base station 300S and the target base station 300T complete the processes for the handover, the target base station 300T informs a mobility management entity (MME) 400 that the handover is completed, and transmits a path switch request to transmit data through a new base station 300. Herein, the MME 400 may communicate with other entities such as a system architecture evolution gateway (S-GW), a packet data network gateway (P-GW), and the like in order to transmit data through the new base station, and, thus, may reset a bearer in a cellular network. Then, the MME 400 transmits an ACK message relevant to the path switch request to the target base station 300T.

Herein, since the WLAN access capability of the UE 100 is found out by the MME 400, if the UE 100 performing a handover has the WLAN access capability, the MME 400 informs a new target base station 300T of this information and transmits a request for WLAN access information broadcast. Further, the target base station 300T receiving the request transmits a UE connect release to the source base station 300S and makes a request for cancellation of WLAN access information broadcast. Herein, the request for cancellation of WLAN access information broadcast transmitted from the target base station to the source base station 300S may be transmitted from the MME 400 to the source base station 300S.

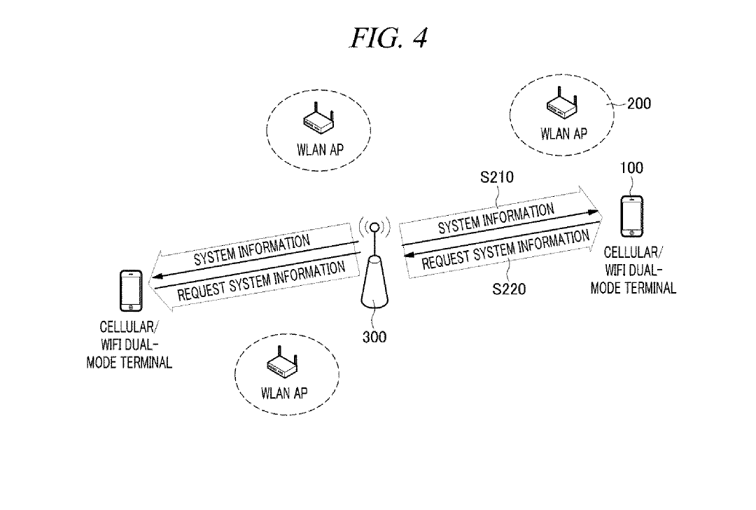

FIG. 4 is a diagram illustrating a method for transferring WLAN information through beamforming to which an exemplary embodiment of the present disclosure is applied.

As illustrated in FIG. 4, when the base station 300 communicates with the UE 100, the base station 300 may perform directional communication through antenna beamforming for the purposes of a wide communication coverage and a high transmission speed (s210). Herein, as a method for implementing the antenna beamforming, the base station 300 may include multiple antenna arrays and adjusts a form of an electrical signal input to each antenna array to adjust a wireless signal to be optimized and then transferred to the UE at a specific location.

Further, the base station 300 may transfer, to the UE 100, only search information of the WLAN AP 200 close to the UE 100 through directional communication. In order to do so, the base station 300 may previously calculate mapping information between a form of beamforming which can be previously created by the base station 300 and a certain physical location or acquire the information from the outside.

To be specific, the base station 300 may previously acquire physical locations where the WLAN Aps 200 are installed in a communication radius of the base station 300. Further, the base station 300 may infer an area where the UE 100 is located by a beamforming pattern on the basis of the acquired information, and then may classify an accessible WLAN AP 200 close to the UE 100.

Further, the UE 100 may request search information of the WLAN AP 200 from the base station 300 (s220). The base station 300 receiving the request may perform a beamforming process with the UE 100 and unicast the search information of the WLAN AP 200 in the area where the UE 100 is located to the UE 100. Therefore, when the UE 100 searches for the WLAN AP 200 close thereto, the UE 100 can efficiently search for WLAN AP 200 using the search information of the WLAN AP 200 received from the base station 300. Herein, the search information of the WLAN AP 200 may include SSID, a WLAN protocol version, information about a channel used, and the like.

The base station 300 and the UE 100 may perform communication through beamforming. During the communication, each of the base station 300 and the UE 100 can acquire directional information. Further, while information about a WLAN close to the UE 100 is transferred, if the WLAN AP 200 has a beamforming function, the base station 300 can previously transfer beamforming characteristics of the WLAN AP 200 previously considering characteristics of the WLAN AP 200 in order for the UE 100 to easily search for the beamforming characteristics.

That is, the base station 300 can acquire or adjust specific directional information through beamforming between the base station 300 and the UE 100 or measurement of arrival of angle (AOA).

The base station 300 can transfer the acquired or adjusted directional information to the WLAN AP 200 or transfer directional information facilitating a WLAN search to the UE 100. Further, the base station 300 can transfer search information of the WLAN AP 200 close to the UE 100 in order for the UE 100 to easily search for information about a WLAN close thereto. Therefore, the UE 100 may perform a search for a neighbor WLAN AP 200 considering the information transferred from the base station 300, and the base station 300 may effectively provide a search for the WLAN AP 200 to the UE 100 on the basis of the beamforming information.

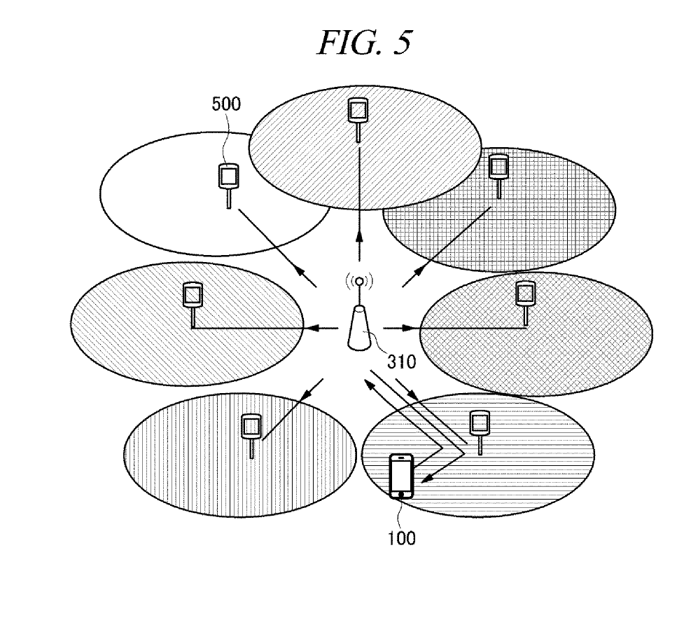

FIG. 5 illustrates a network system to which another exemplary embodiment of the present disclosure is applied.

Referring to FIG. 5, a network system to which another exemplary embodiment of the present disclosure is applied may include a mobile device (User Equipment (UE)) 100, a baseband unit (BBU) 310, and multiple remote radio heads (RRH) 500.

The UE 100 in accordance with an exemplary embodiment of the present disclosure may have two kinds of wireless modules including a WLAN module and a cellular module. Therefore, the UE 100 may perform communication as being connected to a cellular system, or may search for the WLAN AP 200 and access the WLAN AP 200 through a WLAN access process and then transmit data through a WLAN. Herein, the communication with the WLAN uses a different radio frequency from the cellular system connected to the UE 100. Therefore, in order to perform a search for the WLAN AP 200 for WLAN access, the UE 100 may perform a WLAN scanning process for searching another frequency band. Then, the UE 100 may perform a search for the WLAN AP 200 and report search information of the WLAN AP 200 to the baseband unit 310.

Herein, the baseband unit 310 is an entity performing a function of a general base station and refers to a base station supporting a distributed transmission system as being connected to the multiple remote radio heads 500 using optical fiber cables. The remote radio head 500 is configured to receive a wireless signal and transfer the wireless signal to the baseband unit 310.

Further, the UE 100 may search for the WLAN AP 200 and set a measurement gap, and may report measurement information with a search time of the WLAN AP 200 to the baseband unit 130. Herein, parameters used by the UE 100 for setting the measurement gap may include a gap offset, a T value, and WLAN measurement time and may be received from the baseband unit 130. Herein, the WLAN measurement time is a variable value depending on the number of WLAN APs 200 present within a cell of the remote radio head 500 reported by the UE 100. Herein, the WLAN measurement time can be calculated by the following Equation 1.

WLAN−Measurement−Time=Measure−TimeSAP−Channel−Num [Equation 1]

Further, the baseband unit 310 and the UE 100 may indirectly calculate an unavailable section. The baseband unit 310 may transfer search information for detecting the WLAN AP 200 present in the cell of the remote radio head 500 detected and reported by the UE 100 and information about wireless channels to be searched to the UE 100. Therefore, the UE 100 may calculate the WLAN measurement time on the basis of the transferred number of wireless channels. Herein, the measurement time may be defined as a parameter negotiated at the beginning of access to a network of the baseband unit 310 when the UE 100 accesses the network.

Further, the baseband unit 310 is in charge of a function required for calculation such as signal processing and may regularly broadcast a measurement time. Herein, the baseband unit 310 configures multiple remote radio head cells with the multiple remote radio heads 500 connected to the baseband unit 310. Therefore, the baseband unit 310 may transmit search information of the WLAN AP 200 present in a range of a cell which each remote radio head 500 is in charge of to one or more UEs 100 located in a range of a network system including the baseband unit 310 and the remote radio head cell through the remote radio head 500.

The remote radio head 500 may include wireless devices for transmitting/receiving wireless signals, and the remote radio head 500 and the baseband unit 310 may communicate with each other as being connected to each other by an optical fiber cable for the speed of a process. Further, each of the remote radio heads 500 may transmit search information of the WLAN AP 200 present in a range of a cell which the corresponding remote radio head 500 is in charge of to the baseband unit 310 and one or more UEs 100 located in a range of a network system including the baseband unit 310 and the remote radio head cell. Meanwhile, a cell identification (cell ID) which one remote radio head 500 is in charge of may be identical to or different from a cell ID used by the baseband unit 310.

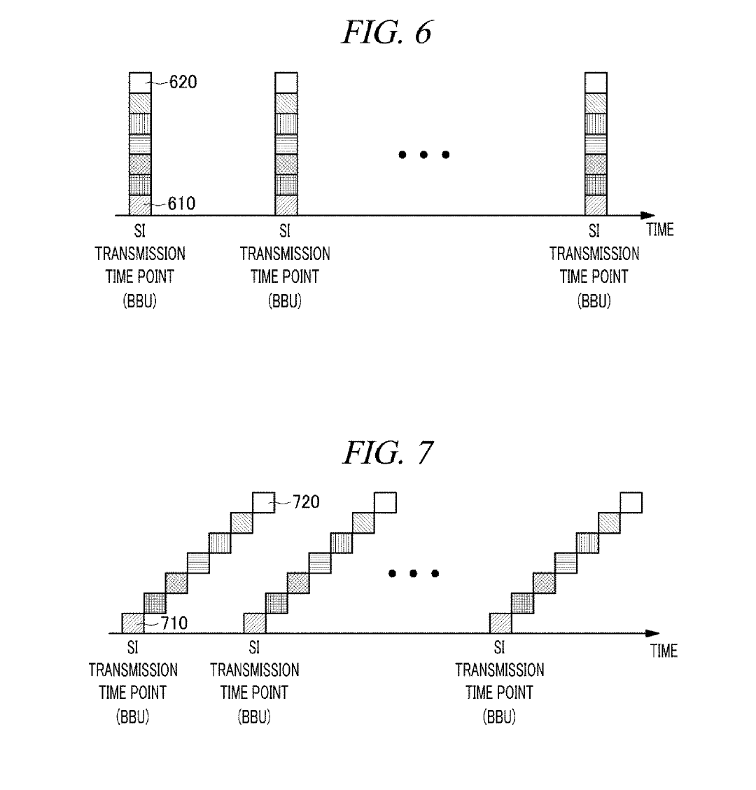

FIG. 6 is a diagram illustrating a method for transmitting WLAN search information in an environment including multiple remote radio head cells to which another exemplary embodiment of the present disclosure is applied.

As illustrated in FIG. 6, in a network system to which an exemplary embodiment of the present disclosure is applied, according to a method for transmitting WLAN search information, if a cell which the multiple radio heads 500 are in charge of is different from a cell ID used by the baseband unit 310, the base station may independently transmit system information. Therefore, when transmitting the system information, the baseband unit 310 may simultaneously transmit search information of the WLAN AP 200 included in a cell radius of the remote radio head 500 to the UE 100 through each remote radio head 500. Otherwise, the baseband unit 310 may transmit some of the system information at the same time and independently transmit some of the system information at different times.

FIG. 7 is a diagram illustrating a method for transmitting WLAN search information to which another exemplary embodiment of the present disclosure is applied in a case where a cell ID which multiple remote radio heads are in charge of is the same as a cell ID used by a baseband unit.

Meanwhile, referring to FIG. 7, in a network system to which another exemplary embodiment of the present disclosure is applied, a cell ID which the multiple radio heads 500 are in charge of may be identical to a cell ID used by the baseband unit 310. Herein, the baseband unit 310 may transmit search information of the WLAN AP 200 included in a cell radius of the remote radio head 500 to the UE 100 through each remote radio head 500 using a dynamic information transfer method. Herein, the dynamic information transfer method refers to a method of transmitting system information or WLAN search information at different times.

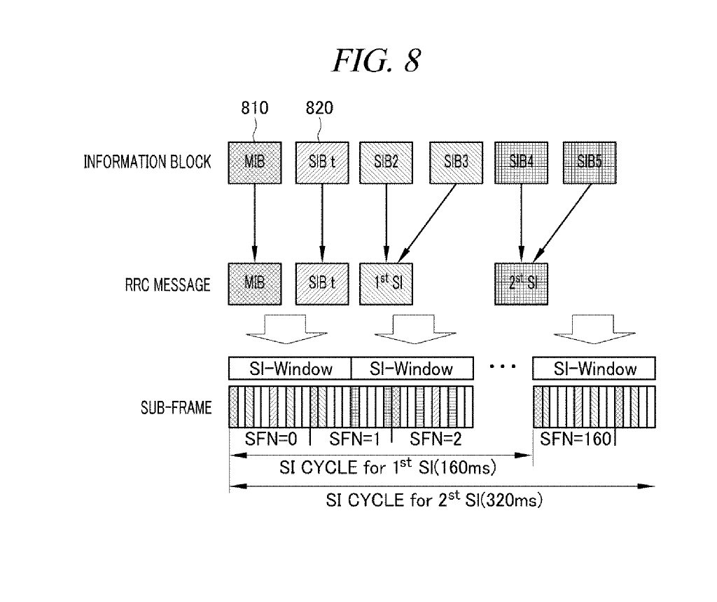

FIG. 8 is a diagram illustrating a dynamic information transfer method of system information in a case where a cell ID which multiple remote radio heads are in charge of is the same as a cell ID used by a baseband unit to which another exemplary embodiment of the present disclosure is applied.

Referring to FIG. 8, in order to transfer system information, an information block including the system information is allotted to any one of a master information block (MIB), a system information block type 1 (SIB1), and system information (SI). Then, MIB 810 and SIB1 820 may be transmitted to fixed locations and SI may be dynamically transmitted by flexible scheduling. Herein, scheduling information about the dynamic transmission of the SI can be seen from the SIB1 820. Therefore, in order for the UE to acquire SI transmission scheduling information, the UE needs to acquire and decode the SIB1 820.

By way of example, the MIB 810 is scheduled at a cycle of 40 ms and may be repeated every 10 ms within 40 ms. Further, the SIB1 820 is scheduled at a cycle of 80 ms and may be repeated every 20 ms within 80 ms. Herein, SI messages may be transmitted into a so-called system information window (SI-window). Therefore, each of the SI messages is interworked with one SI-window, and other SI messages are respectively broadcast as different SI-window values. Herein, the SI should not be overlapped at the same transmission time nor be continuously transferred, and within one SI-window, only SI messages interworked with the SI-window can be transferred. Otherwise, when the SIB1 820 and the SI message are transferred to a downlink shared channel (DL-SCH), the SIB1 820 and the SI message can be transferred using a system information-radio temporary identity (SI-RNTI) in order for all of the SIB1 820 and the SI message within one cell to be decoded at different times.

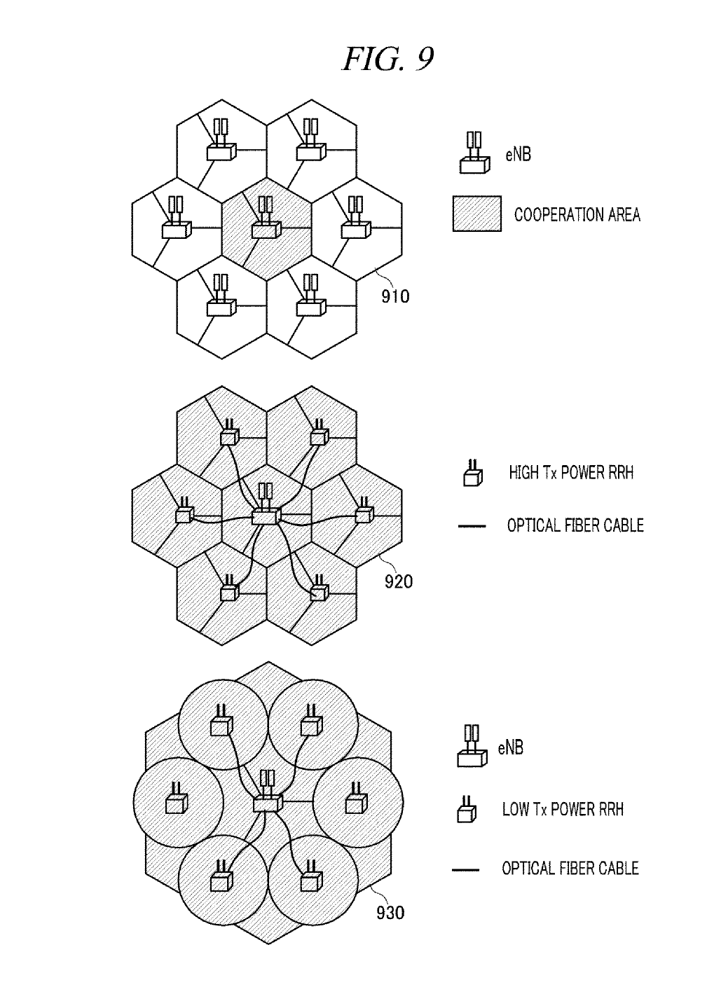

FIG. 9 illustrates an example of cooperative communication among multiple base stations or multiple wireless radio heads in a network system applicable to a method for transmitting WLAN search information to which another exemplary embodiment of the present disclosure is applied.

Referring to FIG. 9, a network system applicable to a method for transmitting WLAN search information in accordance with an exemplary embodiment of the present disclosure may include four scenarios.

Firstly, a first scenario 910 shows a network structure including multiple base stations in which each base station performs inter-cell cooperative communication. Therefore, in the first scenario 910, it is possible to independently transmit information about a WLAN in each cell area to each cell. In an inter-cell cooperative model, information about a WLAN in each cell area can be shared within a site, and, thus, it is possible to independently transmit information about a WLAN to each cell and also possible to transmit information about a WLAN included in a cell within a base station for inter-cell handover. Further, it is possible to support more efficient recognition of or access to a WLAN during inter-cell movement.

Further, a second scenario 920 is similar to the first scenario 910, but in the second scenario 920, a baseband unit is connected to multiple remote radio heads by optical fiber cables to perform inter-cell cooperative communication, and each of the remote radio heads includes an independent cell and thus performs communication with relatively high power. Herein, remote radio heads RRHs connected to one baseband unit (BBU/eNB) operate as high-power radio heads in order to maintain a coverage level of an individual baseband unit. In this case, in order to more effectively recognize a neighbor WLAN and rapidly access the neighbor WLAN, an independent remote radio head needs to transmit WLAN information in each coverage. However, by additionally using characteristics of the optical fiber cables connected to the baseband unit (BBU/eNB), it is possible for each remote radio head to use WLAN information in one baseband unit. Therefore, WLAN information can be grouped by grouping one or more remote radio heads and can be provided to each remote radio head. Accordingly, it is possible to support WLAN access between remote radio heads using WLAN information at a boundary between the remote radio heads beyond a cell area of one remote radio head.

Herein, WLAN-remote radio head ID information is mapped and transmitted in order to inform that whether an individual WLAN is included in a remote radio head coverage while WLAN grouping information is generated. In this case, during a WLAN search, it is possible to priorly search a WLAN in a serving remote radio head (serving RRH) and then, a WLAN in a neighbor remote radio head area. Further, if a WLAN signal is searched from the neighbor remote radio head area, it is considered as a boundary of a remote radio head, and, thus, cooperative communication between remote radio heads can be triggered or a handover or scanning can be started.

Third and fourth scenarios 930 assume a heterogeneous network where transmission points having different transmission powers are present. Inter-base station cooperative communication is performed between low-power remote radio heads and a high-power radio head located in a macro cell area. Herein, in the third scenario, each of the low-power remote radio heads has a cell ID. Further, in the fourth scenario, the low-power remote radio heads have the same cell ID as the macro cell. In other words, the third scenario shows cooperative communication between macro/pico cells, and the fourth scenario shows cooperative transmission between remote radio heads distributed in the whole macro cell area. Herein, the third and fourth scenarios 930 may assume that optical fiber cables are present between the base station and the low-power remote radio heads.

Further, the third scenario shows a situation where a macro cell coexists with a pico or femto cell within an overlapped communication coverage. Therefore, it is possible to access the pico or femto cell to acquire information about a WLAN within the corresponding coverage and access the WLAN. However, a communication area of the pico or femto cell is smaller than that of the macro cell and similar to that of the WLAN. Therefore, if the UE is informed of a limited coverage of the pico or femto cell, it may be difficult to effectively access a neighbor WLAN of the pico or femto cell. Therefore, it is desirable for the pico or femto cell to transmit information about a WLAN in a wider area rather than each coverage area, and the information can be acquired from the macro cell to access the pico or femto cell.

Further, in the third scenario, search information may be updated to additionally manage WLAN information of a hidden node. The macro cell transmits information about a WLAN within the macro cell. Herein, in the case of a WLAN in an area overlapped with the pico or femto cell, additional information about the pico or femto cell is mapped and transmitted to the UE. Thus, when WLAN information is acquired, a handover to the pico or femto cell or an inter-cell cooperation can be triggered. Further, during a search for the pico or femto cell, a neighbor WLAN can be recognized.

Meanwhile, in the fourth scenario, it is impossible for the UE to identify each remote radio head by its cell ID. Therefore, it is not easy to acquire information about a WLAN in a specific remote radio head and the UE can perform communication through multiple remote radio heads. In this case, information of all WLANs within an area of the baseband unit may be transmitted in order to search a WLAN using the information within a remote radio head under the control of the baseband unit. Herein, the amount of the WLAN information may be massive and thus the transmission efficiency may be decreased. Therefore, upon request of the UE for information about a specific remote radio head, limited information may be transmitted to the UE, or information about a WLAN in each of some remote radio heads communicating with a specific UE among all the remote radio heads may be collected and transmitted to the UE.

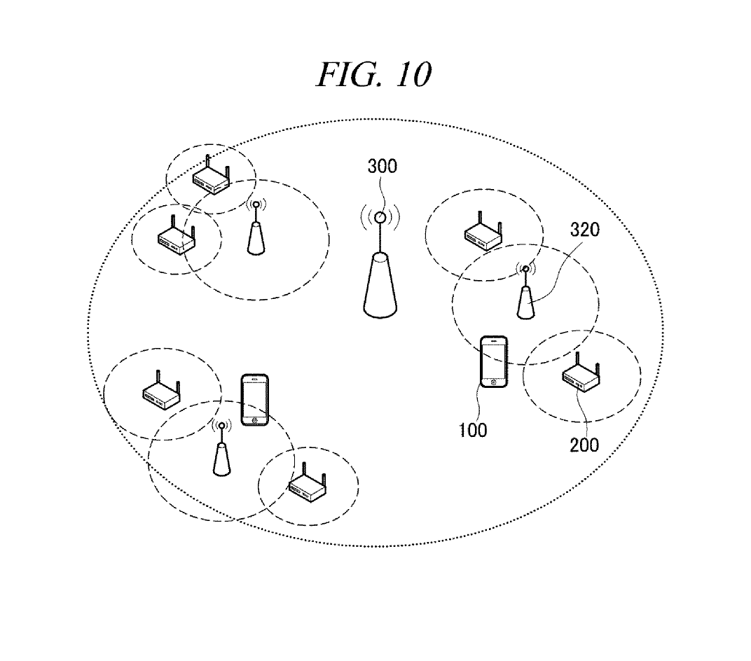

FIG. 10 illustrates a system supporting a WLAN search and a transfer of WLAN search information by a mobile device to which yet another exemplary embodiment of the present disclosure is applied.

Referring to FIG. 10, a system supporting a WLAN search and a transfer of WLAN search information by a mobile device may include the mobile device (User Equipment (UE)) 100, the WLAN access point (WLAN AP) 200, a small cell base station 320 including a small cell area, and a macro base station (Enhanced NodeB (eNB)) or a radio network controller (RNC) 300. Herein, the small cell base station 320 including a small cell area may be any one of a pico cell base station, a femto cell base station, or a relay.

Firstly, the UE 100 includes two kinds of wireless modules including a WLAN module and a cellular module. The UE 100 performs communication as being connected to a cellular system, searches the WLAN AP 200, accesses a WLAN by a link process, and then transmits data through the WLAN. The communication with the WLAN uses a different radio frequency from the cellular system connected to the UE 100, and in order to perform a WLAN search for discovering the WLAN AP 200, the UE 100 may perform a WLAN scanning process for searching another frequency band. Further, the UE 100 may search for the WLAN AP 200 and set a measurement gap, and may report measurement information with a search time of the WLAN AP 200 to the macro base station 300. Herein, parameters used by the UE 100 for setting the measurement gap may include a gap offset, a T value, and WLAN measurement time and may be received from the base station 300. Herein, the WLAN measurement time is a variable value depending on the number of WLAN APs 200 present around the small cell base station 320 reported by the UE 100. Herein, the WLAN measurement time can be calculated by the following Equation 2.

WLAN−Measurement−Time=Measure−TimeSAP−Channel−Num [Equation 2]

Otherwise, the WLAN measurement time may be explicitly informed by the base station 300. In this case, the number of wireless channels used by the WLAN Aps 200 around the reported small cell base station 320 may be indirectly informed.

Further, the base station 300 and the UE 100 may indirectly calculate an unavailable section. The macro base station 300 may transfer search information for detecting the WLAN AP 200 present around the small cell base station 320 detected and reported by the UE 100 and information about wireless channels to be searched to the UE 100. Therefore, the UE 100 may calculate the WLAN measurement time on the basis of the transferred number of wireless channels. Herein, the measurement time may be defined as a parameter negotiated at the beginning of access to a network of the base station 300 when the UE 100 accesses the network.

Meanwhile, if the UE 100 uses multiple wireless modules, a wireless module used for communication with the base station 300 and measurement of a signal quality of a neighbor homogeneous base station is different from a wireless module for searching a WLAN AP. Therefore, it is not necessary to calculate a WLAN measurement time. Further, the UE 100 may independently measure a signal quality of a homogeneous base station using another wireless module and then report the signal quality using a cellular wireless module.

The WLAN AP 200 typically uses a radio resource in an unlicensed band, and, thus, the cost for data communication is lower than the cost for cellular communication. Therefore, it is possible to use a method for transmitting/receiving data using a WLAN in order to reduce a load of the cellular system and process transmitted/received data of the UE at low cost.

The small cell base station 320 refers to a base station using a smaller power than the macro base station 300 and configured to cover a small area for a hotspot or a coverage hole. Therefore, the small cell base station 320 may be classified into a pico cell base station, a femto cell base station, and a relay depending on a size of the coverage. Further, the macro base station 300 is configured to cover a wider area than the small cell base station 320. Therefore, the macro base station 320 uses a greater power than the small cell base station 320.

The macro base station 300 may transfer information which may be used by UE 100 for searching accessible WLAN APs 200 using a communication protocol used by the macro base station 300 and the UE 100 for mutual communication, i.e., a communication protocol through a control plane. Further, the macro base station 300 may give an instruction to the UE 100 to access a WLAN.

Meanwhile, the macro base station 300 may set measurement gap information required by the UE 100 for detecting the small cell base station 320 using a different frequency and parameters to be reported, and may transfer setting parameters to the UE 100. Herein, the setting parameters may include a measurement target, a reporting method, a measurement value to be reported after measurement, a measurement gap, and the like. The measurement target may be transferred as including IDs of the small cell base stations 320 around the WLAN AP 200. Further, the measurement value to be reported after measurement may be set to be lower than a typical set value in order for the macro base station 300 to transfer search information of the WLAN AP 200 on the basis of a location of the UE 100.

Herein, the measurement gap includes repetitions of an available section and an unavailable section. In the available section, the UE 100 constantly monitors control information of the macro base station 300, and, thus, the macro base station 300 can start communication with the UE 100 at any time. Further, in the unavailable section, the UE 100 changes a frequency and measures a wireless signal of another base station. Since the UE 100 changes a frequency different from that of a serving base station and measures a wireless signal of another base station, the macro base station 300 cannot communicate with the UE 100 in the unavailable section.

Meanwhile, as an example of setting a measurement gap, a parameter called “gap offset” and a parameter called “T” may be received from the macro base station 300 and an unavailable section for measuring a signal quality may be calculated as shown in the following Equation 2.

A super frame number (SFN) indicating a start of the unavailable section is as shown in the following Equation 3.

SFN mod T=FLOOR(gapOffset/10) [Equation 3]

A sub-frame number indicating a start of the unavailable section in the SFN can be calculated using the following Equation 4.

Subframe=gapOffset mod 10 [Equation 4]

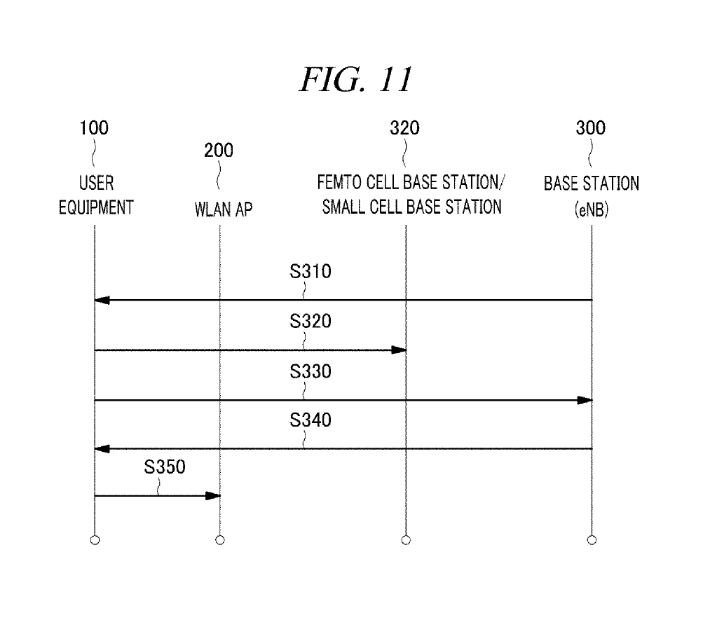

FIG. 11 is a detailed flowchart showing a method of a WLAN search and a transfer of WLAN search information by a mobile device to which yet another exemplary embodiment of the present disclosure is applied.

Referring to FIG. 11, a method of a WLAN search and a transfer of WLAN search information by a mobile device in accordance with yet another exemplary embodiment of the present disclosure may include: receiving information about the small cell base station 320 included in a management range of the macro base station 300 from the macro base station 300 by the UE 100 (s310); searching the small cell base station 320 by the UE 100 (s320); transferring the information about the small cell base station 320 searched by the UE 100 to the macro base station 300 (s330); receiving search information of the WLAN AP 200 in a local area of the UE 100 from the base station 300 by the UE 100 (s340); and performing a search for the WLAN AP 200 on the basis of the search information of the WLAN APs 200 received by the UE 100 (s350).

Firstly, in the receiving information about the small cell base station 320 by the UE 100 (s310), the UE 100 may receive information about the small cell base station 320 included in a management range of the macro base station 300 from the macro base station 300. The macro base station 300 may set measurement gap information required by the UE 100 for detecting the small cell base station 320 using a different frequency and parameters to be reported, and may transfer setting parameters to the UE 100. Herein, the setting parameters may include a measurement target, a reporting method, a measurement value to be reported after measurement, a measurement gap, and the like. Further, the measurement target may be transferred as including IDs of the small cell base stations 320 around the WLAN AP 200.

Then, in the searching the small cell base station 320 by the UE 100 (s320), the UE 100 may search the small cell base station 320 or measure a wireless signal quality of the small cell base station 320.

Then, if the small cell base station 320 is detected, in the transferring the information about the small cell base station 320 searched by the UE 100 to the macro base station 300 (s330), the UE 100 may report the information about the small cell base station 320 searched by the UE 100 to the macro base station 300 and the macro base station 300 may receive the information about the small cell base station 320 searched by the UE 100. With the report about the small cell base station 320 detected by the UE 100, the macro base station 300 may find out a location of the UE 100.

Further, the macro base station 300 may find out the location of the UE 100 and transfer search information of the WLAN AP 200 in a local area of the UE 100 to the UE 100. Then, the UE 100 may receive the search information of the WLAN AP 200 in the local area of the UE 100 from the base station 300 (s340).

Then, in the performing a search for the WLAN AP 200 on the basis of the search information of the WLAN APs 200 received by the UE 100 (s350), the UE 100 may search for the WLAN AP 200 using the search information of the WLAN APs 200 received from the macro base station 300.

Then, a search result of the WLAN AP 200 may be reported to the macro base station 300, and the macro base station 300 may give an instruction to access to a WLAN on the basis of the reported information.

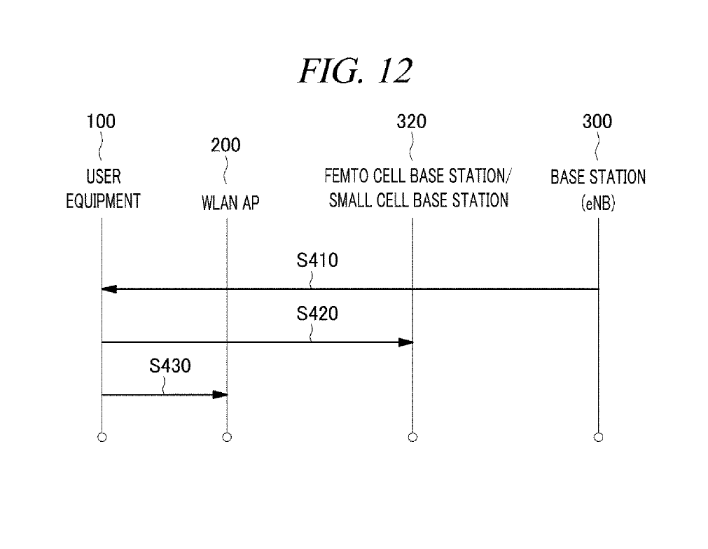

FIG. 12 is a detailed flowchart showing a method of a WLAN search and a transfer of WLAN search information by a mobile device to which still another exemplary embodiment of the present disclosure is applied.

Referring to FIG. 12, a method of a WLAN search and a transfer of WLAN search information by a mobile device in accordance with an exemplary embodiment of the present disclosure may include: receiving information about the small cell base station 320 around a WLAN adjacent to the UE 100 among the small cell base stations 320 included in a management range of the macro base station 300 from the macro base station 300 by the UE 100 (s410); searching the small cell base station 320 by the UE 100 (s420); and performing a search for the WLAN AP 200 if the UE 100 searches the small cell base station 320 (s430).

Firstly, in the receiving information about the small cell base station 320 by the UE 100 (s410), the UE 100 may receive information about the small cell base station 320 around the WLAN AP 200 adjacent to the UE 100 among the small cell base stations 320 included in a management range of the macro base station 300 from the macro base station 300. The macro base station 300 may transfer the information about the small cell base stations 320 included in the management range of the macro base station 300 to the UE 100. Herein, the macro base station 300 may perform a set-up required by the UE 100 for detecting the small cell base station 320, and may transfer setting parameters to the UE 100. Herein, the setting parameters may include a measurement target, a reporting method, a measurement value to be reported after measurement, a measurement gap, and the like. Further, the measurement target may be transferred as including IDs of the small cell base stations 320 around the WLAN AP 200. The measurement value to be reported after measurement may be set to be lower than a typical set value in order for the macro base station 300 to transfer search information of the WLAN AP 200 on the basis of a location of the UE 100.

Then, in the searching the small cell base station 320 by the UE 100 (s420), the UE 100 may search the small cell base station 320 or measure a wireless signal quality of the small cell base station 320.

If the small cell base station 320 is detected, the UE 100 may search for the WLAN AP 200 adjacent to the small cell base station 320 on the basis of the information about the small cell base station 320 searched by the UE 100 (s430). Herein, the UE 100 may report a search result of the WLAN AP 200 to the macro base station 300, and the macro base station 300 may give an instruction to access to a WLAN on the basis of the reported information.

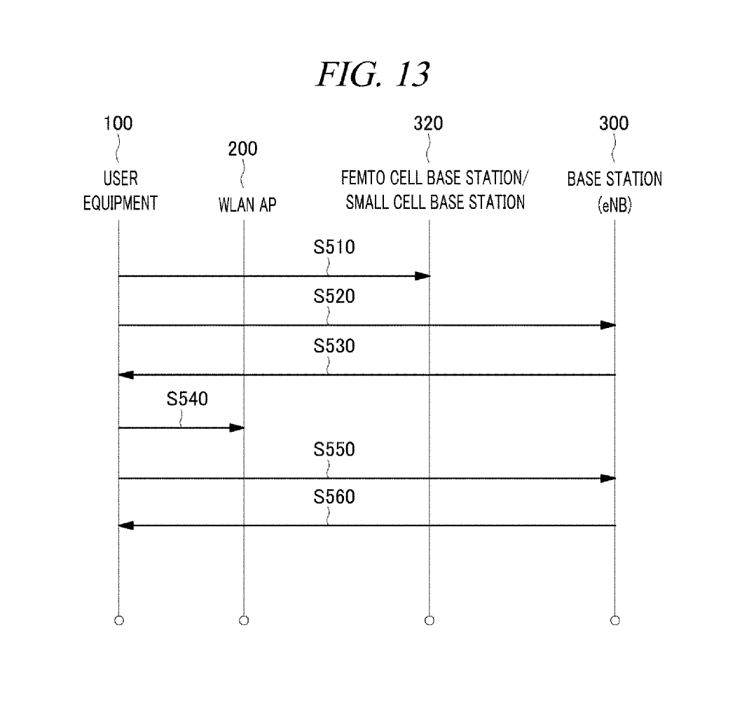

FIG. 13 is a detailed flowchart showing a method of a WLAN search and a transfer of WLAN search information by a mobile device to which still another exemplary embodiment of the present disclosure is applied.

Referring to FIG. 13, a method of a WLAN search and a transfer of WLAN search information by a mobile device in accordance with still another exemplary embodiment of the present disclosure may include: searching the small cell base station 320 around the UE 100 by the UE 100 (s510); transferring information about the small cell base station 320 searched by the UE 100 to the macro base station 300 (s520); receiving an instruction to search for the WLAN AP 200 around the small cell base station 320 from the macro base station 300 (s530); searching the WLAN AP 200 by the UE 100 (s540); transferring a search result of the WLAN AP 200 to the macro base station 300 by the UE 100 (s550); and receiving an instruction to move to the WLAN AP 200 from the macro base station 300 by the UE 100 (s560).

Firstly, in the searching the small cell base station 320 around the UE 100 by the UE 100 (s510), the UE 100 may search the small cell base station 320 or measure a wireless signal quality of the small cell base station 320.

Then, in the transferring information about the small cell base station 320 searched by the UE 100 to the macro base station 300 (s520), if the UE 100 reports the searched information about the small cell base station 320 to the macro base station 300, the macro base station 300 may receive the information about the small cell base station 320 around the UE 100 searched by the UE 100. Therefore, with the report about the small cell base station 320 detected by the UE 100, the macro base station 300 may find out a location of the UE 100.

Then, in the receiving an instruction to search for the WLAN AP 200 around the small cell base station 320 from the macro base station 300 (s530), the macro base station 300 may give an instruction to the UE 100 to search for the WLAN AP 200 in a local area of the small cell base station 320 around the UE 100, and the UE 100 may receive the instruction to search for the WLAN AP 200 around the small cell base station 320.

Further, the macro base station 300 may perform a set-up required by the UE 100 for detecting the WLAN AP 200 around the small cell base station 320, and may transfer setting parameters to the UE 100. Herein, the setting parameters may include a measurement target, a reporting method, a measurement value to be reported after measurement, a measurement gap, and the like. Further, the measurement target may be transferred as including IDs of the small cell base stations 320 around the WLAN AP 200. Furthermore, the measurement value to be reported after measurement may be set to be lower than a typical set value in order for the macro base station 300 to transfer search information of the WLAN AP 200 on the basis of a location of the UE 100.

Then, in the searching the WLAN AP 200 by the UE 100 (s540), the UE 100 may search the WLAN AP 200.

Then, in the transferring a search result of the WLAN AP 200 to the macro base station 300 by the UE 100 (s550), if the UE 100 reports the information about the searched WLAN AP 200 to the macro base station 300, the macro base station 300 may receive a result of the WLAN AP 200 searched by the UE 100.

Then, in the receiving an instruction to move to the WLAN AP 200 from the macro base station 300 by the UE 100 (s560), the macro base station 300 may transfer an instruction to move to the WLAN AP 200 in the local area of the UE 100 among the WLAN Aps 200 searched by the UE 100, and the UE 100 may receive the instruction to move to the WLAN AP 200. Then, the macro base station 300 may give an instruction to the UE 100 to access to a WLAN. Therefore, the UE 100 can access the WLAN more efficiently.

A method for transmitting wireless LAN information according to an exemplary embodiment of the present disclosure may include: transmitting information about a wireless LAN access point located in each of multiple areas included in a base station to a mobile device located in each area by the base station. Herein, the base station may transmit the information about the wireless LAN access point through a communication protocol for control.

Further, the method for transmitting wireless LAN information according to an exemplary embodiment of the present disclosure may further include: receiving a request for the information about the wireless LAN access point, and in the transmitting information about a wireless LAN access point, the information about the wireless LAN access point may be unicast to the mobile device that transmits the request.

Furthermore, the method for transmitting wireless LAN information according to an exemplary embodiment of the present disclosure may further include: receiving a request for the information about the wireless LAN access point from the mobile device, and in the transmitting information about a wireless LAN access point, the information about the wireless LAN access point may be broadcast to mobile devices in an area including the mobile device that transmits the request.

Moreover, in the method for transmitting wireless LAN information according to an exemplary embodiment of the present disclosure, the information about the wireless LAN access point may include one or more of a wireless network service set identification (SSID), a wireless LAN protocol version, information about a channel used, and the like.

Further, the method for transmitting wireless LAN information according to an exemplary embodiment of the present disclosure may further include: accessing the base station by the mobile device; receiving wireless LAN access capability information from the mobile device by the base station; and managing information about the mobile device accessible to the wireless LAN by the base station. Herein, in the transmitting information about a wireless LAN access point, the information about the wireless LAN access point may be transmitted with reference to the information about the mobile device accessible to the wireless LAN.

Furthermore, in the managing information about the mobile device accessible to the WLAN by the base station, the base station may manage the information about the mobile device on the basis of location information transmitted by the mobile device.

Moreover, in the managing information about the mobile device accessible to the wireless LAN by the base station, the base station may manage information relevant to a handover of the mobile device.

Further, the wireless LAN access capability information may include one or more of whether or not it is possible to support a wireless LAN, a supportable wireless network service set identification (SSID), and whether or not it is possible to perform data redirection or data forwarding.

Furthermore, the managing information about the mobile device accessible to the WLAN by the base station may include classifying a state of the mobile device into a RRC_Idle state or a RRC_Connected state. Herein, the mobile device in the RRC_Idle state may regularly update its location information to the base station, and the location information may include the wireless LAN access capability information.

Moreover, in the transmitting information about a wireless LAN access point of the method for transmitting wireless LAN information according to an exemplary embodiment of the present disclosure, the information about the wireless LAN AP may be transmitted to mobile devices respectively located in multiple sectors included in the base station.

Further, in the method for transmitting wireless LAN information according to an exemplary embodiment of the present disclosure, the multiple areas may include areas formed by beamforming, and in the transmitting information about a wireless LAN access point, the information about the wireless LAN AP may be transmitted to mobile devices respectively located in the areas formed by beamforming.

Furthermore, in the transmitting information about a wireless LAN access point of the method for transmitting wireless LAN information according to an exemplary embodiment of the present disclosure, the information about the wireless LAN access point located around a specific device may be transmitted to the device by beamforming on the basis of a location of a mobile device found from a beamforming pattern and location information of the wireless LAN access point.

Moreover, the method for transmitting wireless LAN information according to an exemplary embodiment of the present disclosure may further include: receiving a request for cancellation of providing the information about the wireless LAN access point from a target base station newly accessed by the mobile device according to a handover process of the mobile device.

A method for searching a wireless LAN according to another exemplary embodiment of the present disclosure may include: receiving information about a wireless LAN access point by a mobile device from a base station; and performing a wireless LAN search on the basis of the received information about the wireless LAN access point. Herein, the information about the wireless LAN access point relates to a wireless LAN access point located in each of multiple areas included in the base station and also relates to a wireless LAN access point included in an area where the mobile device is located.

Further, in the receiving information about a wireless LAN access point of the method for searching a wireless LAN according to another exemplary embodiment of the present disclosure, the information about the wireless LAN access point may be received through a communication protocol for control.

Furthermore, the method for searching a wireless LAN according to another exemplary embodiment of the present disclosure may further include: requesting the information about the wireless LAN access point from the base station. Herein, in the receiving information about a wireless LAN access point, the mobile device may receive the information transmitted from the base station by unicast.

Moreover, the method for searching a wireless LAN according to another exemplary embodiment of the present disclosure may further include: requesting the information about the wireless LAN access point from the base station. Herein, in the receiving information about a wireless LAN access point, mobile devices in an area including the mobile device may receive the information transmitted from the base station by broadcast.

Further, the information about the wireless LAN access point of the method for searching a wireless LAN according to another exemplary embodiment of the present disclosure may include one or more of a wireless network service set identification (SSID), a wireless LAN protocol version, information about a channel used, and the like.

Furthermore, the method for searching a wireless LAN according to another exemplary embodiment of the present disclosure may further include: accessing the base station by the mobile device; and transmitting wireless LAN access capability information to the base station by the mobile device.

Moreover, the multiple areas in the method for searching a wireless LAN according to another exemplary embodiment of the present disclosure may include multiple sectors. Herein, the receiving information about a wireless LAN access point may include receiving information about a wireless LAN access point included in a sector in which the mobile device is located.

Otherwise, the multiple areas in the method for searching a wireless LAN according to another exemplary embodiment of the present disclosure may include areas formed by beamforming. Herein, the receiving information about a wireless LAN access point may include receiving information about a wireless LAN access point included in an area which is formed by beamforming and in which the mobile device is located.

Further, in the method for searching a wireless LAN according to another exemplary embodiment of the present disclosure, the receiving information about a wireless LAN access point may include receiving information about a wireless LAN access point located around the mobile device by beamforming.

Furthermore, in the method for searching a wireless LAN according to another exemplary embodiment of the present disclosure, if there is a wireless LAN access point having a beamforming function, the information about the wireless LAN access point may include beamforming characteristics of the wireless LAN access point.

A method for transmitting information about a wireless LAN according to yet another exemplary embodiment of the present disclosure may include: configuring, by a baseband unit, multiple remote radio head cells with multiple remote radio heads connected to the baseband unit; and transmitting information about a wireless LAN access point present within a range of the baseband unit or information about a wireless LAN access point present within a range of a cell which at least one remote radio head is in charge of to one or more mobile devices located in a range of a network system including the baseband unit and the remote radio head cells.

Further, in the method for transmitting information about a wireless LAN according to yet another exemplary embodiment of the present disclosure, the baseband unit and the remote radio head may have different identifiers. Herein, in the transmitting information about a wireless LAN access point to mobile devices, the respective remote radio heads may transmit the information about the wireless LAN access point at the same time.

Otherwise, in the method for transmitting information about a wireless LAN according to yet another exemplary embodiment of the present disclosure, the baseband unit and the remote radio head may have different identifiers. Herein, in the transmitting information about a wireless LAN access point to mobile devices, the respective remote radio heads may independently transmit the information about the wireless LAN access point.

Further, in the method for transmitting information about a wireless LAN according to yet another exemplary embodiment of the present disclosure, the baseband unit and the remote radio head may have the same identifier. Herein, in the transmitting information about a wireless LAN access point to mobile devices, the respective remote radio heads may transmit the information about the wireless LAN access point at different times.

Furthermore, in the transmitting information about a wireless LAN access point to mobile devices of the method for transmitting information about a wireless LAN according to yet another exemplary embodiment of the present disclosure, the respective remote radio heads may transmit information about wireless LAN APs included in their cells and information about wireless LAN APs included in cells adjacent to the respective remote radio head cells to the mobile device.

Further, the transmitting information about a wireless LAN access point to mobile devices of the method for transmitting information about a wireless LAN according to yet another exemplary embodiment of the present disclosure may include: grouping remote radio head cells adjacent to each other by the baseband unit; transmitting information about wireless LAN access points included in the grouped remote radio head cells to remote radio heads included in each group; and transmitting the transmitted information about wireless LAN access points of each group to a mobile device by each remote radio head.

Furthermore, in the method for transmitting information about a wireless LAN according to yet another exemplary embodiment of the present disclosure, the remote radio head may include one or more macro cells and one or more small cells. Herein, in the transmitting information about a wireless LAN access point to a mobile device, if wireless LAN information is transmitted to a mobile device located in a macro cell, information about a wireless LAN access point in the macro cell may be transmitted. Further, if a wireless LAN included in the macro cell is overlapped with an area of a small cell, information about the small cell may also be transmitted.

Otherwise, in the transmitting information about a wireless LAN access point to mobile devices, if wireless LAN information is transmitted to a mobile device located in a small cell, information about a wireless LAN access point in the small cell may be transmitted and information about a wireless LAN access point included in a macro cell adjacent to the small cell may also be transmitted.

Otherwise, in the transmitting information about a wireless LAN access point to mobile devices, if wireless LAN information is transmitted to a mobile device located in a small cell, information about a wireless LAN access point in the small cell may be transmitted and the mobile device may be guided to update wireless LAN search information.

Further, in the method for transmitting information about a wireless LAN according to yet another exemplary embodiment of the present disclosure, the baseband unit and the remote radio head may have the same identifier. Herein, in the transmitting information about a wireless LAN access point to mobile devices, information about a wireless LAN access point located in the baseband unit may be transmitted.

A network system according to still another exemplary embodiment of the present disclosure may include: a baseband unit; and multiple remote radio heads connected to the baseband unit. Herein, the baseband unit transmits information about a wireless LAN access point present within a range of a cell which the remote radio heads are in charge of to one or more mobile devices located in a range of a network system.

Further, in the network system according to still another exemplary embodiment of the present disclosure, the baseband unit and each remote radio head may be connected through a wire communication network.

Furthermore, in the network system according to still another exemplary embodiment of the present disclosure, the baseband unit and the remote radio head may have different identifiers. Herein, the baseband unit may transmit the information about the wireless LAN access point at the same time through the respective remote radio heads.

Otherwise, in the network system according to still another exemplary embodiment of the present disclosure, the baseband unit and the remote radio head may have different identifiers, and the baseband unit may independently transmit the information about the wireless LAN access point through the respective remote radio heads.

Further, in the network system according to still another exemplary embodiment of the present disclosure, the baseband unit and the remote radio head may have the same identifier. Herein, the baseband unit may transmit the information about the wireless LAN access point at different times through the respective remote radio heads.

Furthermore, in the network system according to still another exemplary embodiment of the present disclosure, the baseband unit and the respective remote radio heads may transmit information about wireless LAN APs included in their cells and information about wireless LAN APs included in cells adjacent to the respective remote radio head cells to the mobile device.

Moreover, in the network system according to still another exemplary embodiment of the present disclosure, the base unit may group remote radio head cells adjacent to each other and transmit information about wireless LAN access points included in the grouped remote radio head cells to remote radio heads included in each group. Herein, each remote radio head may transmit the transmitted information about wireless LAN access points of each group to a mobile device.

Further, in the network system according to still another exemplary embodiment of the present disclosure, the remote radio head may include one or more macro cells and one or more small cells. Herein, if wireless LAN information is transmitted to a mobile device located in a macro cell, the baseband unit transmits information about a wireless LAN access point within the macro cell, and if a wireless LAN included in the macro cell is overlapped with an area of a small cell, the base unit may also transmit information about the small cell.

Furthermore, in the network system according to still another exemplary embodiment of the present disclosure, the remote radio head may include one or more macro cells and one or more small cells. Herein, if wireless LAN information is transmitted to a mobile device located in a small cell, the baseband unit may transmit information about a wireless LAN access point in the small cell and may also transmit information about a wireless LAN access point included in a macro cell adjacent to the small cell.

Otherwise, if wireless LAN information is transmitted to a mobile device located in a small cell, the baseband unit may transmit information about a wireless LAN access point in the small cell and guide the mobile device to update wireless LAN search information.

Further, in the network system according to still another exemplary embodiment of the present disclosure, the base station and the remote radio head may have the same identifier. Herein, the base station may transmit information about a wireless LAN access point located in the baseband unit to the mobile device.

A method for access to a wireless LAN according to still another exemplary embodiment of the present disclosure may include: receiving information about a wireless LAN access point by a mobile device from a remote radio head; and performing access to the wireless LAN access point on the basis of the received information about the wireless LAN access point. Herein, the remote radio head accesses a baseband unit, and each remote radio head transmits information about a wireless LAN access point present within a range of a cell which the remote radio head is in charge of or information about a wireless LAN access point present within a range of the baseband unit.

Further, in the method for access to a wireless LAN according to still another exemplary embodiment of the present disclosure, the baseband unit and the remote radio head may have different identifiers. Herein, the information about the wireless LAN access point transmitted to the mobile device may be transmitted by the respective remote radio heads connected to the baseband unit at the same time.

Otherwise, the information about the wireless LAN access point transmitted to the mobile device may be independently transmitted by the respective remote radio heads connected to the baseband unit.

Furthermore, in the method for access to a wireless LAN according to still another exemplary embodiment of the present disclosure, the baseband unit and the remote radio head may have the same identifier. Herein, the information about the wireless LAN access point transmitted to the mobile device may be transmitted by the respective remote radio heads connected to the baseband unit at different times.

Otherwise, as the information about the wireless LAN access point, information about a wireless LAN access point located in the baseband unit may be transmitted.

Moreover, in the method for access to a wireless LAN according to still another exemplary embodiment of the present disclosure, the baseband unit and the remote radio head may have the same identifier, and the information about the wireless LAN access point transmitted to the mobile device may be transmitted by the respective remote radio heads connected to the baseband unit at different times.

Further, in the method for access to a wireless LAN according to still another exemplary embodiment of the present disclosure, the information about the wireless LAN access point may include information about a wireless LAN access point included in a remote radio head cell and information about a wireless LAN access point included in a cell adjacent to the remote radio head cell.

Further, in the method for access to a wireless LAN according to still another exemplary embodiment of the present disclosure, the information about the wireless LAN access point may include information about wireless LAN access points included in cells of remote radio heads grouped by the baseband unit.

Furthermore, in the method for access to a wireless LAN according to still another exemplary embodiment of the present disclosure, the remote radio head may include one or more macro cells and one or more small cells. Herein, if the mobile device is located in a small cell, the information about the wireless LAN access point may include information about a wireless LAN access point in a small cell and information about a wireless LAN access point included in a macro cell adjacent to the small cell.

Moreover, in the method for access to a wireless LAN according to still another exemplary embodiment of the present disclosure, the remote radio head may include one or more macro cells and one or more small cells. Herein, if the mobile device is located in a small cell, the information about the wireless LAN access point may include information about a wireless LAN access point in a small cell and the mobile device may perform a wireless LAN search and update search information of a wireless LAN in the small cell.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A method for searching a wireless LAN by a mobile device, comprising:
searching a small cell base station;
transferring information about the searched small cell base station to a macro base station;
receiving search information of wireless LAN access points in a local area of the mobile device from the macro base station; and
performing a search for a wireless LAN access point on the basis of the received search information of the wireless LAN access points.

2. The method for searching a wireless LAN of claim 1, further comprising:
receiving information about a small cell base station included in a management range of the macro base station from the macro base station.

3. The method for searching a wireless LAN of claim 1,
wherein the macro base station sets measurement gap information required by the mobile device for detecting a small cell base station using a different frequency and parameters to be reported, and transfers setting parameters together with the information about the small cell base station to the mobile device.

4. The method for searching a wireless LAN of claim 3,
wherein the parameters to be reported include one or more of a measurement target, a reporting method, a measurement value to be reported after measurement, and a measurement gap.

5. The method for searching a wireless LAN of claim 1,
wherein in the transferring information about the searched small cell base station to a macro base station,
the mobile device sets a measurement gap including a search time of a wireless LAN access point, and transfers the set value to the macro base station after measurement.

6. The method for searching a wireless LAN of claim 5,
wherein a parameter used for setting the measurement gap includes one or more of a gap offset, a T value, and WLAN measurement time.

7. The method for searching a wireless LAN of claim 1,
wherein in the receiving search information of wireless LAN access points in a local area of the mobile device from the macro base station,
the mobile device receives information about wireless LAN access points in a local area of the searched small cell base station.

8. A method for searching a wireless LAN by a mobile device, comprising:
receiving, from the macro base station, information about a small cell base station located around a wireless LAN adjacent to the mobile device among small cell base stations included in a management range of a macro base station;
searching the small cell base station; and
searching wireless LAN access points around the small cell base station.

9. The method for searching a wireless LAN of claim 8,
wherein the searching wireless LAN access points around the small cell base station includes:
transferring, by the mobile device, information about the searched small cell base station to the macro base station;
receiving, by the mobile device, search information of the wireless LAN access points around the searched small cell base station from the macro base station; and
performing, by the mobile device, a search for a wireless LAN access point on the basis of the received search information of the wireless LAN access points.

10. The method for searching a wireless LAN of claim 8,
wherein in the receiving, from the macro base station, information about a small cell base station located around a wireless LAN adjacent to the mobile device among small cell base stations included in a management range of a macro base station,
the macro base station sets measurement gap information required by the mobile device for detecting a small cell base station using a different frequency and parameters to be reported, and transfers setting parameters together with the information about the small cell base station to the mobile device.

11. The method for searching a wireless LAN of claim 10,
wherein the parameters to be reported include one or more of a measurement target, a reporting method, a measurement value to be reported after measurement, and a measurement gap.

12. The method for searching a wireless LAN of claim 10,
wherein a parameter used for setting the measurement gap includes one or more of a gap offset, a T value, and WLAN measurement time.

13. A method for transferring wireless LAN search information by a macro base station, comprising:
transferring information about a small cell base station included in a management range of a macro base station to a mobile device;
receiving information of a small cell base station searched by the mobile device; and
transferring search information of a wireless LAN access point in a local area of the mobile device to the mobile device.

14. The method for transferring wireless LAN search information of claim 13,
wherein in the transferring information about a small cell base station included in a management range of a macro base station to a mobile device,
the macro base station sets measurement gap information required by the mobile device for detecting a small cell base station using a different frequency and parameters to be reported, and transfers setting parameters together with the information about the small cell base station to the mobile device.

15. The method for transferring wireless LAN search information of claim 13,
wherein the information about the small cell base station includes one or more of a cell identifier, a wireless network service set identification (SSID), a WLAN protocol version, and information about a channel used.
